(19) United States
(12) Patent Application Publication
(10) Pub. No.: US 2024/0357476 A1
(43) Pub. Date: Oct. 24, 2024

(54) IMPROVEMENTS IN AND RELATING TO CONTROL PLANE DATA TRANSMISSION

(71) Applicant: SAMSUNG ELECTRONICS CO., LTD., Suwon-si, Gyeonggi-do (KR)

(72) Inventor: Mahmoud WATFA, Staines (GB)

(21) Appl. No.: 18/684,621

(22) PCT Filed: Aug. 17, 2022
(86) PCT No.: PCT/KR2022/012281

§ 371 Date: Feb. 16, 2024

(30) Foreign Application Priority Data
Aug. 18, 2021 (GB) 2111878.1
Aug. 16, 2022 (GB) 2211940.8

(51) Int. Cl. H04W 48/08; H04W 48/18; H04W 84/04

(52) U.S. Cl. CPC H04W 48/08; H04W 48/18; H04W 84/042

(57) ABSTRACT

The disclosure relates to 5th generation (5G) and/or 6th generation (6G) communication system for supporting a higher data transmission rate. Embodiments herein provide a method of controlling an user equipment (UE) transmitting data over a control plane (CP) including prohibiting the UE from transmitting the data over the CP when a 5G Session Management (5GS.M) timer is running.

### TECHNICAL FIELD

This disclosure relates to a method to back off user equipments (UEs) from control plane (CP) data transmission.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHZ” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

An aspect of the disclosure provides a method of controlling an user equipment (UE) transmitting data over a control plane (CP) including prohibiting the UE from transmitting the data over the CP when a 5G Session Management (5GSM) timer is running.

The UE may be prohibited from transmitting the data over at least one of a non-access stratum (NAS) associated with a Data Network Name (DNN), a slice identification (ID), single network slice selection assistance information (S-NSSAI), or a combination of the S-NSSAI and DNN.

The method may include prohibiting the UE from initiating a service request procedure or a non-access stratum (NAS) transport procedure for the transmitting the data over the CP when a timer T3396 may be running or deactivated.

The method may include prohibiting the UE from initiating a service request procedure or a non-access stratum (NAS) transport procedure for the transmitting the data over the CP when a timer T3584 is running or deactivated.

The method may include prohibiting the UE from initiating a service request procedure or a non-access stratum (NAS) transport procedure for transmitting the data over the CP when timer a T3585 is running or deactivated.

Prohibition may be lifted when the UE is configured for high priority access or to report a change of 3GPP PS data off UE status.

The method may include sending to the UE a Back Off (BO) timer without an associated 5GMM cause, and blocking data transmission over the CP.

The UE may stop the BO timer when cellular internet of things (CIoT) user data is received. The BO timer may be one of T3396, T3584 and T3585.

The UE may be configured to operate in a S1 mode and the UE may be configured to receive an evolved packet system session management (ESM DATA) transport message directly as a non-access stratum (NAS) message.

An aspect of the disclosure provides an user equipment (UE) transmitting data over a control plane (CP) and including a transceiver, and at least one processor coupled with the transceiver and configured to be prohibited to transmit the data over the CP when a 5G Session Management (5GSM) timer is running.

The UE may be configured to be prohibited from transmitting the data over at least one of a non-access stratum (NAS) associated with a Data Network Name (DNN), a slice identification (ID), single network slice selection assistance information (S-NSSAI), or a combination of the S-NSSAI and DNN.

The UE may be configured to be prohibited from initiating a service request procedure or a non-access stratum (NAS) transport procedure for the transmitting the data over the CP when a timer T3396 is running or deactivated.

The UE may be configured to be prohibited from initiating a service request procedure or a non-access stratum (NAS) transport procedure for the transmitting the data over the CP when a timer T3584 is running or deactivated.

The UE may be configured to be prohibited from initiating a service request procedure or a non-access stratum (NAS) transport procedure for transmitting the data over the CP when timer a T3585 is running or deactivated.

Prohibition may be lifted when the UE is configured for high priority access or to report a change of 3GPP PS data off UE status.

The UE may be configured to receive a Back Off (BO) timer without an associated 5GMM cause, and the UE does not transmit the data over the CP in response to receiving the BO timer.

The UE may stop the BO timer when cellular internet of things (CIoT) user data is received.

The BO timer may be one of T3396, T3584 and T3585.

The UE may be configured to operate in a S1 mode and the UE may be configured to receive an evolved packet system session management (ESM DATA) transport message directly as a non-access stratum (NAS) message.

### BRIEF DESCRIPTION OF DRAWINGS

The above and other aspects, features, and advantages of certain embodiments of the disclosure will be more apparent from the following detailed description taken in conjunction with the accompanying drawings, in which:

FIG. 1 illustrates a flowchart illustrating transmitting data over a control plane according to an embodiment;

FIG. 2 illustrates a flowchart illustrating transmitting data over a control plane according to an embodiment;

FIG. 3 illustrates a structure of a UE according to an embodiment; and

FIG. 4 illustrates a structure of a base station according to an embodiment.

### BEST MODE FOR CARRYING OUT THE INVENTION

Hereinafter, embodiments of the disclosure will be described in detail with reference to the accompanying drawings. In the disclosure, embodiments are described in the drawings and a related detailed description is set forth, but this is not intended to limit the embodiments of the disclosure. Descriptions of well-known functions and constructions are omitted for the sake of clarity and conciseness.

The term couple refers to any direct or indirect communication between two or more elements, whether or not those elements are in physical contact with one another. The terms transmit, receive, and communicate encompass both direct and indirect communication. The terms include and comprise, mean inclusion without limitation. The term or is inclusive, meaning and/or. The term controller means any device, system or part thereof that controls at least one operation. A controller can be implemented in hardware or a combination of hardware and software and/or firmware. The functionality associated with any particular controller can be centralized or distributed, whether locally or remotely. At least one of, when used with a list of items, means that different combinations of one or more of the listed items can be used, and only one item in the list can be needed. For example, at least one of A, B, and C includes any of the following combinations: A, B, and C; A and B; A and C; B and C; and A and B and C. For example, at least one of A, B, or C includes any of the following combinations: A, B, and C; A and B; A and C; B and C; and A and B and C.

Moreover, various functions described below can be implemented or supported by one or more computer programs, each of which is formed from computer readable program code and embodied in a computer readable medium. The terms application and program refer to one or more computer programs, software components, sets of instructions, procedures, functions, objects, classes, instances, related data, or a portion thereof adapted for implementation in a suitable computer readable program code. The phrase computer readable program code includes any type of computer code, including source code, object code, and executable code. The phrase computer readable medium includes any type of medium capable of being accessed by a computer, such as read-only memory (ROM), random access memory (RAM), a hard disk drive, a compact disc (CD), a digital video disc (DVD), or any other type of memory. A non-transitory computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Terms used herein to describe the embodiments of the present disclosure are not intended to limit and/or define the scope of the present disclosure. For example, unless otherwise defined, the technical terms or scientific terms used in the present disclosure shall have the ordinary meaning understood by those with ordinary skills in the art to which the present disclosure belongs.

It should be understood that first, second and similar words used in the present disclosure do not express any order, quantity or importance, but are only used to distinguish different components. Unless otherwise indicated by the context clearly, similar words such as a, an or the in a singular form do not express a limitation of quantity, but express an existence of at least one.

As used herein, any reference to one example or example, one embodiment or embodiment means that particular elements, features, structures or characteristics described in connection with the embodiment are included in at least one embodiment. The phrases in one embodiment or in one example appearing in different places of the disclosure do not necessarily refer to the same embodiment.

The various embodiments discussed below for describing the principles of the present disclosure are for illustration only and should not be interpreted as limiting the scope of the present disclosure in any way. Those skilled in the art will understand that the principles of the present disclosure can be implemented in any suitably arranged wireless communication system. For example, although the following detailed description of the embodiments of the present disclosure will be directed to LTE and 5G communication system, those skilled in the art can understand that the main points of the present disclosure can also be applied to other communication systems with similar technical backgrounds and channel formats with slight modifications without departing from the scope of the present disclosure. For example, the communication systems may include a global system for mobile communications (GSM) system, code division multiple access (CDMA) system, wideband code division multiple access (WCDMA) system, general packet radio service (GPRS), long term evolution (LTE) system, LTE frequency division duplex (FDD) system, LTE time division duplex (TDD), UMTS, worldwide interoperability for microwave access (WiMAX) communication system, a 5G system or new radio (NR), etc. In addition, the technical schemes of the embodiments of the application can be applied to future-oriented communication technologies.

The Fifth Generation System, 5GS, supports the control of congestion at the Session Management (5GSM) level (in addition to the Mobility Management (5GMM) level). To back-off UEs due to congestion, the network provides different back-off (BO) timers depending on the reason for congestion. For example:
T3396 is used to control BO for a Data Network Name, DNN
T3584 is used to control BO for an S-NSSAI (slice ID) and a DNN combination
T3585 is used to control BO for an S-NSSAI

When the UE starts a timer (any one of the above) for congestion control, the UE is prohibited from sending any signalling that is associated with the congested DNN, or S-NSSAI, or S-NSSAI and DNN combination. However, the UE can still have user plane resources established even when any of these timers is running. This is because the timer is to control signalling messages and not user plane traffic. Example signalling messages that would be prohibited include: messages to establish a Protocol Data Unit, PDU, session (e.g. PDU Session Establishment Request) or messages to modify a session (e.g. PDU Session Modification Request). Note that there are some exceptions to this general rule as described in 3GPP TS 24.501 V17.3.1.

On the mobility management level (i.e. the 5GMM level), a similar concept exists. One of the ways to avoid sending NAS over the control plane due to congestion is to provide the UE with the BO timer T3448. While this timer is running, the UE in idle mode is not allowed to send data over the control plane as specified in 3GPP TS 24.501 V17.3.1 from which the text below is sourced:

The network may activate congestion control for transport of user data via the control plane, as specified in 3GPP TS 23.501 [8].

If the UE has indicated support for the control plane CIoT 5GS optimizations and the network decides to activate the congestion control for transport of user data via the control plane, the network may include a value for the control plane data back-off timer T3448 in REGISTRATION ACCEPT, SERVICE ACCEPT or SERVICE REJECT message, and shall store an control plane data back-off time on a per UE basis. The UE starts the timer T3448 with the value informed in the message. To avoid that large numbers of UEs simultaneously initiate deferred requests, the network should select the value for the timer T3448 for the informed UEs so that timeouts are not synchronised.

The network sends REGISTRATION ACCEPT message or SERVICE ACCEPT message without T3448 value IE to stop the timer T3448 running in the UE as specified in subclause 5.5.1.3.4 and subclause 5.6.1.4.

Based on the stored control plane data back-off time for the UE, the network may reject the transfer of user data via the control plane initiated by the UE.

While the timer T3448 is running, the UE in 5GMM-IDLE mode does not initiate the transport of user data via the control plane procedure, except if the UE is allowed to use exception data reporting (see the ExceptionDataReportingAllowed leaf of the NAS configuration MO in 3GPP TS 24.368 or the USIM file EFNASCONFIG in 3GPP TS 31.102 [22]) and the user data is related to an exceptional event.

The UE is allowed:
a) to respond to paging with CONTROL PLANE SERVICE REQUEST message without uplink data; or
b) to send a CONTROL PLANE SERVICE REQUEST message for emergency services or for emergency services fallback;
even if the timer T3448 is running.

Upon entering the state 5GMM-DEREGISTERED or a new PLMN which is not equivalent to the PLMN where the UE started the timer T3448, or upon being switched off while the timer T3448 is running, the UE stops the timer T3448.”

As can be seen, the timer T3448 can be provided in the Registration Accept, Service Accept or the Service Reject messages as described in 3GPP TS 24.501 V17.3.1. Note that the timer also applies for a UE in S1 mode (i.e. Evolved Packet System, EPS) in which the timer can be provided in the Attach Accept, Tracking Area Update (TAU) Accept, Service Accept and Service Reject messages as described in 3GPP TS 24.301 V17.3.0. The following describes the use of T3448:

The network may activate congestion control for transport of user data via the control plane, as specified in 3GPP TS 23.401 [10].

If the congestion control for transport of user data via the control plane is active and if the UE has indicated support for the control plane data back-off timer, the network shall include a value for the control plane data back-off timer T3448 in ATTACH ACCEPT, TRACKING AREA UPDATE ACCEPT, SERVICE ACCEPT or SERVICE REJECT message, and shall store an control plane data back-off time on a per UE basis. The UE starts the timer T3448 with the value informed in the message. To avoid that large numbers of UEs simultaneously initiate deferred requests, the network should select the value for the timer T3448 for the informed UEs so that timeouts are not synchronised.

The network sends TRACKING AREA UPDATE ACCEPT message or SERVICE ACCEPT message without T3448 value IE to stop the timer T3448 running in the UE as specified in clause 5.5.3.2.4 and clause 5.6.1.4.2.

Based on the stored control plane data back-off time for the UE, the network may reject the transfer of user data via the control plane initiated by the UE.

While the timer T3448 is running, the UE in EMM-IDLE mode shall not initiate the transport of user data via the control plane procedure (see clause 6.6.4), except if the UE is allowed to use exception data reporting (see the ExceptionDataReportingAllowed leaf of the NAS configuration MO in 3GPP TS 24.368 [15A] or the USIM file EFNASCONFIG in 3GPP TS 31.102 [17]) and the user data is related to an exceptional event.

Upon entering the state EMM-DEREGISTERED or a new PLMN which is not equivalent to the PLMN where the UE started the timer T3448, or upon being switched off while the timer T3448 is running, the UE shall stop the timer T3448. For further criteria to stop of timer T3448, refer to clause 5.5.3.2.4 and clause 5.6.1.4.2.”

Note that one key difference between a UE in N1 mode (in 5GS) versus a UE in S1 mode (EPS) is that for the former, the UE need not negotiate the support of control plane congestion control for data, whereas in S1 mode the UE and the network should negotiate whether they both support the feature. As such, in 5GS, at least the UE is expected to support the feature.

It should also be noted that in some cases, the Access and Mobility Management Function, AMF, applies 5GSM level congestion control by sending the necessary BO timer and 5GMM cause code during a Non-access stratum, NAS, transport procedure (i.e. using the Downlink, DL, NAS TRANSPORT message). When this is received in the UE and by the 5GMM entity, the received information i.e. the BO timer and the cause code, is passed to the 5GSM entity. Here it should be noted that the 5GSM will start the necessary timer based on the received value and it should be noted that the purpose of this timer is to prevent 5GSM signalling from being sent by the UE. The text below is from section 5.4.5.3.2 in 3GPP TS 24.501 V17.3.1:

“. . . SKIP . . .

In case f) in subclause 5.4.5.3.1, i.e. upon sending a single uplink 5GSM message which was not forwarded due to congestion control, the AMF shall:
a) include the PDU session ID in the PDU session ID IE;
b) set the Payload container type IE to “N1 SM information”;
c) set the Payload container IE to the 5GSM message which was not forwarded;
d) set the 5GMM cause IE to the 5GMM cause #22 “Congestion”, the 5GMM cause #67 “insufficient resources for specific slice and DNN” or the 5GMM cause #69 “insufficient resources for specific slice”; and
e) include the Back-off timer value IE.

. . . SKIP . . .

For case 12) in subclause 5.4.5.3.1, i.e. upon sending a single uplink CIoT user data container which was not forwarded due to congestion control, the AMF shall:
a) include the PDU session ID in the PDU session ID IE;
b) set the Payload container type IE to “CIoT user data container”;
c) set the Payload container IE to the CIoT user data container which was not forwarded;
d) set the 5GMM cause IE to the 5GMM cause #22 “Congestion” and include the Back-off timer value IE.

. . . SKIP . . . ”

The text below is from section 5.4.5.3.3 in 3GPP TS 24.501 V17.3.1:

“. . . SKIP . . .
g) “N1 SM information” and:
1) the 5GMM cause IE is set to the 5GMM cause #22 “Congestion”, the UE passes to the 5GSM sublayer an indication that the 5GSM message was not forwarded due to DNN based congestion control along with the 5GSM message from the Payload container IE of the DL NAS TRANSPORT message, and the time value from the Back-off timer value IE;
2) the 5GMM cause IE is set to the 5GMM cause #28 “Restricted service area”, the UE passes to the 5GSM sublayer an indication that the 5GSM message was not forwarded due to service area restrictions along with the 5GSM message from the Payload container IE of the DL NAS TRANSPORT message, enters the state 5GMM-REGISTERED.NON-ALLOWED-SERVICE and, if the DL NAS TRANSPORT message is received over 3GPP access, performs the registration procedure for mobility and periodic registration update without waiting for the release of the NI NAS signalling connection (see subclauses 5.3.5 and 5.5.1.3);
3) the 5GMM cause IE is set to the 5GMM cause #65 “maximum number of PDU sessions reached”, the UE passes to the 5GSM sublayer an indication that the 5GSM message was not forwarded because the PLMN's maximum number of PDU sessions has been reached, along with the 5GSM message from the Payload container IE of the DL NAS TRANSPORT message;
4) the 5GMM cause IE is set to the 5GMM cause #67 “insufficient resources for specific slice and DNN”, the UE passes to the 5GSM sublayer an indication that the 5GSM message was not forwarded due to S-NSSAI and DNN based congestion control along with the 5GSM message from the Payload container IE of the DL NAS TRANSPORT message, and the time value from the Back-off timer value IE;
5) the 5GMM cause IE is set to the 5GMM cause #69 “insufficient resources for specific slice”, the UE passes to the 5GSM sublayer an indication that the 5GSM message was not forwarded due to S-NSSAI only based congestion control along with the 5GSM message from the Payload container IE of the DL NAS TRANSPORT message, and the time value from the Back-off timer value IE;

. . . SKIP . . .
1) “CIoT user data container” and:
   1) the 5GMM cause IE is set to the 5GMM cause #22 “Congestion”, the UE passes to the 5GSM sublayer an indication that the CIoT user data was not forwarded due to DNN based congestion control along with the CIoT user data from the Payload container IE of the DL NAS TRANSPORT message, and the time value from the Back-off timer value IE.
   2) the 5GMM cause IE is set to the 5GMM cause #90 “payload was not forwarded”, the UE passes to the 5GSM sublayer an indication that the user data container was not forwarded due to routing failure along with the user data container from the Payload container IE and the PDU session ID from the PDU session ID IE of the DL NAS TRANSPORT message.

. . . SKIP . . . ”

Document C1-214386 (C1-214386, CR #3429, 3GPP TSG-CT WG1 Meeting #131-c, Handling abnormal case of no “allowed NSSAI” in REGISTRATION ACCEPT) proposes the following changes to the sections that are referenced above i.e. 5.4.5.3.2 and 5.4.5.3.3 of 3GPP TS 24.501 V17.3.1:

“For case 12) in subclause 5.4.5.3.1, i.e. upon sending a single uplink CIoT user data container which was not forwarded due to congestion control, the AMF shall:
a) include the PDU session ID in the PDU session ID IE;
b) set the Payload container type IE to “CIoT user data container”;
c) set the Payload container IE to the CIoT user data container which was not forwarded;
d) set the 5GMM cause IE to the 5GMM cause #22 “Congestion”, the 5GMM cause #67 “insufficient resources for specific slice and DNN” or the 5GMM cause #69 “insufficient resources for specific slice”; and
e) include the Back-off timer value IE.”
“1) “CIoT user data container” and:

1) the 5GMM cause IE is set to the 5GMM cause #22 “Congestion”, the 5GMM cause #67 “insufficient resources for specific slice and DNN” or the 5GMM cause #69 “insufficient resources for specific slice”, the UE passes to the 5GSM sublayer an indication that the CIoT user data was not forwarded due to DNN based congestion control along with the CIoT user data from the Payload container IE of the DL NAS TRANSPORT message, and the time value from the Back-off timer value IE.”

Finally, the following is from 3GPP TS 24.501 V17.3.1 that shows what the indicated timers really achieve in terms of the type of prohibitions when they are running:

“If T3396 is running or is deactivated, then the UE is neither allowed to initiate the PDU session establishment procedure nor the PDU session modification procedure for the respective DNN or without a DNN unless the UE is a UE configured for high priority access in selected PLMN or to report a change of 3GPP PS data off UE status.

If the timer T3584 is running or is deactivated for all the PLMNs and is associated with [no S-NSSAI, no DNN] or [no S-NSSAI, DNN] combination, then the UE is neither allowed to initiate the PDU session establishment procedure nor the PDU session modification procedure for [no S-NSSAI, no DNN] or [no S-NSSAI, DNN] combination in any PLMN unless the UE is a UE configured for high priority access in selected PLMN or to report a change of 3GPP PS data off UE status.

If T3585 is running or is deactivated, then the UE is neither allowed to initiate the PDU session establishment procedure nor the PDU session modification procedure for the respective S-NSSAI unless the UE is a UE configured for high priority access in selected PLMN or to report a change of 3GPP PS data off UE status.”

As can be seen, the primary objective of these timers is to stop 5GSM signalling.

A problem with the prior art methods used to apply congestion control to Cellular Internet of Things, CIoT, user data, in particular, as part of the NAS transport procedure is that is not effective.

The following problems are identified in the prior art:
1. Sending a BO timer with the cause codes #22, #67, or #69 in the DL NAS TRANSPORT message does not stop further transmissions of data over the control plane, this only stops the sending of 5GSM messages as have been clearly demonstrated previously from 3GPP TS 24.501 V17.3.1. As such, if the objective is to stop data over NAS due to congestion, a different mechanism is required or at least the current mechanism should be updated.
2. The timer T3448 seems to only be applicable to UEs in idle mode, which means that when the UE is in connected mode, it can send data over NAS even though there is congestion.

It is an aim of embodiments of the present disclosure to address these and other shortcomings whether mentioned herein or not.

According to the present disclosure there is provided an apparatus and method as set forth in the appended claims. Other features of the disclosure will be apparent from the dependent claims, and the description which follows.

According to an aspect of the present disclosure, there is provided a method of controlling a User Equipment's, UE's, transmission of Control Plane, CP, data wherein the UE is prohibited from transmitting data over the CP if a 5G Session Management, 5GSM, timer is running.

In an embodiment, the UE is prohibited from transmitting data over a non-access stratum, NAS, associated with a Data Network Name, DNN, a slice ID, S-NSSAI, or a combination of the S-NSSAI and DNN.

In an embodiment, if timer T3396 is running or deactivated, then the UE is

prohibited from initiating a service request procedure or a NAS transport procedure for the transfer/transport of data over the CP.

In an embodiment, if timer T3584 is running or deactivated, then the UE is prohibited from initiating a service request procedure or a NAS transport procedure for the transfer/transport of data over the CP.

In an embodiment, if timer T3585 is running or deactivated, then the UE is prohibited from initiating a service request procedure or a NAS transport procedure for the transfer/transport of data over the CP.

In an embodiment, the prohibition is lifted if the UE is configured for high priority access or to report a change of 3GPP PS data off UE status.

According to an aspect of the present disclosure, there is provided a method of controlling a User Equipment's, UE's, transmission of Control Plane, CP, data wherein a connected network sends to the UE a Back Off, BO, timer, without an associated 5GMM cause, thereby blocking data transmission over the CP.

In an embodiment, he UE stops the BO timer if CIoT user data is received.

In an embodiment, the BO timer is one of T3396, T3584 and T3585.

In an embodiment, the UE is operating in S1 mode and the UE receives an ESM DATA TRANSPORT message directly as a NAS message.

According to a third aspect of the present disclosure, there is provided apparatus arranged to perform the method of an aspect.

Although a few preferred embodiments of the present disclosure have been shown and described, it will be appreciated by those skilled in the art that various changes and modifications might be made without departing from the scope of the disclosure, as defined in the appended claims.

For a better understanding of the disclosure, and to show how embodiments of the same may be carried into effect, reference will now be made, by way of example only, to the accompanying diagrammatic drawings in which:

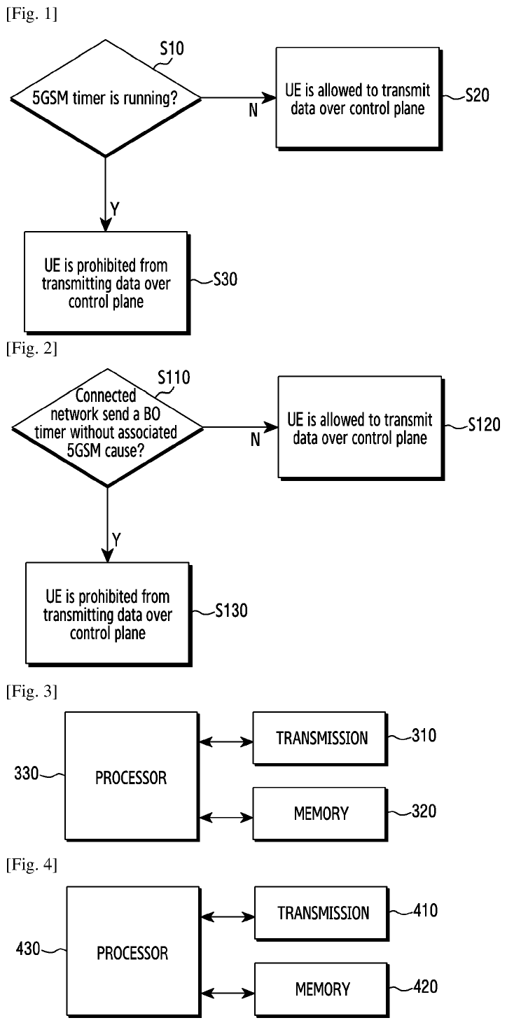

FIG. 1 is a flowchart illustrating an embodiment of the present disclosure; and

FIG. 2 is a flowchart illustrating an embodiment of the present disclosure.

In an embodiment, there is provided an updated mechanism to also prohibit sending of data over the control plane.

In an embodiment, when any of the 5GSM timers are running, the UE should not send data over NAS that is associated with the DNN, or the S-NSSAI and DNN combination, or the S-NSSAI.

In addition to the prior art restrictions when T3396 is running as specified above, if T3396 is running or is deactivated, then the UE is further not allowed to initiate the service request procedure (and as such the UE is not allowed to send the Control Plane Service Request message) for the transport/transfer of data over the control plane (or data over NAS) for the respective DNN or without a DNN unless the UE is a UE configured for high priority access in selected PLMN or to report a change of 3GPP PS data off UE status.

In addition to the prior art restrictions when T3396 is running as specified above, if T3396 is running or is deactivated, then the UE is not allowed to initiate the NAS transport procedure for the transport/transfer of data over the control plane (or data over NAS) for the respective DNN or without a DNN unless the UE is a UE configured for high priority access in selected PLMN or to report a change of 3GPP PS data off UE status. The UE not being allowed to initiate the NAS transport procedure for the transfer of control plane data can mean that the UE is not allowed to send the UL NAS TRANSPORT message with CIoT user data container, or the UE is not allowed to send the UL NAS TRANSPORT message with the Payload container type IE set to “CIoT user data container” and/or with the Payload container IE to the user data container such that the user data container is carrying CIoT user data (under the indicated conditions or except in the indicated exceptions).

In addition to the prior art restrictions when T3584 is running as specified above, if the timer T3584 is running or is deactivated (optionally for all) for the PLMN(s) and is associated with [no S-NSSAI, no DNN] or [no S-NSSAI, DNN] combination, then the UE is not allowed to initiate the service request procedure (and as such the UE is not allowed to send the Control Plane Service Request message) for the transport/transfer of data over the control plane (or data over NAS) for the respective DNN or without a DNN unless the UE is a UE configured for high priority access in selected PLMN or to report a change of 3GPP PS data off UE status.

In addition to the prior art restrictions when T3584 is running as specified above, if T3584 is running or is deactivated, then the UE is not allowed to initiate the NAS transport procedure for the transport/transfer of data over the control plane (or data over NAS) for the [no S-NSSAI, no DNN] combination or for [no S-NSSAI, DNN] combination unless the UE is a UE configured for high priority access in selected PLMN or to report a change of 3GPP PS data off UE status. The UE not being allowed to initiate the NAS transport procedure for the transfer of control plane data can mean that the UE is not allowed to send the UL NAS TRANSPORT message with CIoT user data container, or the UE is not allowed to send the UL NAS TRANSPORT message with the Payload container type IE set to “CIoT user data container” and/or with the Payload container IE to the user data container such that the user data container is carrying CIoT user data (under the indicated conditions or except in the indicated exceptions).

In addition to the prior art restrictions when T3585 is running as specified above, if the timer T3585 is running or is deactivated, then the UE is not allowed to initiate the service request procedure (and as such the UE is not allowed to send the Control Plane Service Request message) for the transport/transfer of data over the control plane (or data over NAS) for the respective S-NSSAI unless the UE is a UE configured for high priority access in selected PLMN or to report a change of 3GPP PS data off UE status.

In addition to the prior art restrictions when T3585 is running as specified above, if T3585 is running or is deactivated, then the UE is not allowed to initiate the NAS transport procedure for the transport/transfer of data over the control plane (or data over NAS) for the respective S-NSSAI (or no S-NSSAI, that is associated with the PDU session) unless the UE is a UE configured for high priority access in selected PLMN or to report a change of 3GPP PS data off UE status. The UE not being allowed to initiate the NAS transport procedure for the transfer of control plane data can mean that the UE is not allowed to send the UL NAS TRANSPORT message with CIoT user data container, or the UE is not allowed to send the UL NAS TRANSPORT message with the Payload container type IE set to “CIoT user data container” and/or with the Payload container IE to the user data container such that the user data container is carrying CIoT user data (under the indicated conditions or except in the indicated exceptions).

For all of the enhancements above, another exception to the rule above (i.e. another exception that would allow the UE to send data using the listed NAS messages or procedures) is unless the UE is allowed to use exception data reporting (see the ExceptionDataReportingAllowed leaf of the NAS configuration MO in 3GPP TS 24.368), or the UE had set or uses the Radio Resource Control, RRC, establishment cause to mo-ExceptionData to transitioning to 5GMM-CONNECTED mode, or the UE had used the mo-ExceptionData establishment cause when it had established its current NAS connection.

Note that the details set out above apply equally for all the timers that are mentioned and the restriction would be associated with the corresponding parameter that is associated with the particular timer e.g. T3396 is associated with DNN congestion, and so on.

With the details above, this means that before the UE can send any data over NAS, where the NAS message may be a Control Plane Service Request or UL NAS TRANSPORT message, the UE must verify whether any of the timers (e.g. T3396, T3584, or T3585) are running. If yes, then the UE should not send the CIoT user data (using the mentioned NAS messages) unless there is an exception as described above. The UE can send the data over NAS (using the mentioned NAS messages) when none or all of these timers are not running.

Consequently, when the UE receives a DL NAS TRANSPORT message with the Payload container type IE set to “CIoT user data container”, then the UE should stop T3396 if it is running, or the UE should stop T3584 if it is running, or the UE should stop T3585 if it is running.

Consequently, when the UE in S1 mode receives a ESM DATA TRANSPORT message, then the UE should stop T3396 if it is running, or the UE should stop T3584 if it is running, or the UE should stop T3585 if it is running.

An embodiment of the disclosure provides an alternative solution to block data over the control plane during the NAS transport procedure.

This embodiment provides that the network sends a BO timer but optionally without a 5GMM cause and, as such, the BO timer is to block data transmission over the control plane and, optionally, the BO timer is applicable for all PDU sessions that the UE has. The BO timer may be enforced in the 5GMM entity or in the 5GSM entity. The network (e.g. AMF) can take the proposed action above when the network (e.g. AMF) determines to apply congestion control for data over NAS (and optionally for other signalling) where the AMF may be configured to do so (e.g. using OAM—Operation And Maintenance) or based on local policies in the AMF.

Optionally, the BO timer that the AMF should use should be T3448 (i.e. T3448 value IE in the DL NAS TRANSPORT, or ESM DATA TRANSPORT in the case of MME in S1 mode/EPS), where the AMF may include any 5GMM cause e.g. #22 or any new cause to indicate congestion for data over control plane. As such, the AMF can (and should) send T3448 value IE in the DL NAS TRANSPORT in order to apply congestion control for data over the control plane.

When the UE receives a BO timer in the DL NAS TRANSPORT message and the Payload container type IE is set to “CIoT user data container”, the UE should start the BO timer and the UE should not send (i.e. the UE should block) CIoT user data from being sent over any NAS message except if the UE is a high priority UE or the data is for exception reporting (or the UE has used or is using the RRC establishment cause with a value set to mo-ExceptionData). This behaviour may be applied in the 5GMM entity or the 5GSM entity. As such, the 5GMM entity may provide the BO timer to the 5GSM entity.

As such, if the UE receives T3448 value IE in the DL NAS TRANSPORT message, the UE should start the timer T3448 with the received value.

Furthermore, when the UE is running T3448 (or when T3448 is running in the UE), the UE should not send any data over the control plane (using the Control Plane Service Request or the UL NAS TRANSPORT) regardless of the UE being in 5GMM-IDLE mode or 5GMM-CONNECTED mode (or regardless of being in EMM-IDLE mode or EMM-CONNECTED mode, for the case of S1 mode capable UE). As such, the UE should also not send data over the control plane (using the Control Plane Service Request or the UL NAS TRANSPORT) while T3448 is running even when the UE is in 5GMM-CONNECTED mode, or in 5GMM-CONNECTED mode with RRC inactive indication.

As such, the UE need not verify the mode it is in, but rather the UE only needs to verify if T3448 is running and if so then the UE should block the transmission of data over the control plane (using the Control Plane Service Request or the UL NAS TRANSPORT) until the timer expires or the timer is stopped as described in 3GPP TS 24.501 V17.3.1.

Note that the methods above can be enforced and applied in the 5GMM entity or the 5GSM entity.

Consequently, if the UE receives a DL NAS TRANSPORT message with the Payload container type IE is set to “CIoT user data container” and optionally without any BO timer, then the UE should stop the BO timer that is running, where the BO timer is either a new timer (as proposed above) or the timer T3448.

The network (e.g. AMF) can send the Configuration Update Command message, e.g. based on its local policies to either start or end congestion or to update a BO timer value, and include the BO timer that has been proposed above where the BO timer may be T3448 value IE. The network can set the value accordingly. However, if the network wants to stop the congestion, the network (e.g. AMF) may set the value of the timer to indicate zero.

If the UE receives a BO timer e.g. T3448 value IE in the CONFIGURATION UPDATE COMMAND message then the UE shall replace the stored BO timer value e.g. T3448 value, with the received value in the BO timer e.g. T3448 value IE, and if the value indicates neither zero nor deactivated then the UE should use the received value e.g. T3448 value, as the value of the BO timer e.g. as the value for T3448, the next time the timer (e.g. T3448) is started. If the received BO timer e.g. T3448 value is zero or deactivated, then the UE shall stop the BO timer e.g. the UE stops T3448, if it is running.

Note that all the details herein apply also to EPS where possible and appropriate. e.g. when T3396 is running in S1 mode, then the UE should optionally not send any data over the control plane (e.g. using the Control Plane Service Request message or the ESM DATA TRANSPORT message) when T3396 is running.

Consequently, if the UE receives the ESM DATA TRANSPORT message optionally where the NAS message does not contain a BO timer (e.g. T3448 value IE), optionally where the message is received in EMM-CONNECTED mode, the UE may stop T3396 if it is running. Note that this may also apply to the other timers e.g. T3584 or T3585 if these timers were started in 5GS (N1 mode) for a PDU session that is transferred to EPS (S1 mode).

When T3448 is running for a UE in S1 mode, the UE should not send the ESM DATA TRANSPORT message e.g. when the UE is in EMM-CONNECTED mode. As such, the UE should verify for this condition in order to determine whether to send the data or not using the indicated NAS message.

Note that the network e.g. MME, can also send a BO timer in the ESM DATA TRANSPORT message and the same details above would apply for both the network and the UE in S1 mode. Similarly, any exceptions to the rule that were defined above can also apply to S1 mode. E.g. the UE in EMM-CONNECTED mode (in S1 mode) should not send data using the ESM DATA TRANSPORT message when T3448 is running except if the data is for exception reporting or except as previously described above.

Note that there may be cases of the UE being a Rel-16 that is connected with a Rel-17 network and, as such, the UE may not be able to understand or behave per the methods set out above. As such, the above may be applicable to a Rel-17 UE. One way to solve this problem is that the network e.g. AMF, sends the new BO timer e.g. T3448 value IE, in addition to the Back-off timer value IE and optionally in addition to the existing 5GMM cause codes such as #22, #67 or #69 in the DL NAS TRANSPORT message. When the UE (Rel-17 UE or UEs of further releases) receives the DL NAS TRANSPORT message with both timers, the UE (Rel-17 UE or UEs of further releases) optionally only processes one of the timers e.g. the timer T3448 value IE, as described above, and optionally the UE ignores the other time e.g. Back-off timer value IE. If the UE only receives one timer e.g. the existing Back-off timer value IE in the DL NAS TRANSPORT, then this means the UE is communicating with a Rel-16 network and hence the UE can behave as already described above e.g. the UE passes the BO timer value and the 5GMM cause that was received to the 5GSM entity. Note that when the network e.g. AMF, sends both timers in the DL NAS TRANSPORT message as described herein, the timer T3448 value IE (or a new BO timer) should optionally be sent (or placed in the message such that it is) after the existing Back-off timer value IE in the DL NAS TRANSPORT message.

Note that for all the steps above that use the ESM DATA TRANSPORT message, the proposals may optionally apply only if the content is CIoT data, or all data types including SMS, etc.

For the sake of completeness, FIG. 1 is a flowchart illustrating an embodiment of the disclosure. In step S10, a check may be made to determine if a 5GSM timer (e.g. T3396, T3584, T3585) is running. For example, the UE may determine (or, identify or check) whether a 5GSM timer is running or activated. As another example, an external server may identify whether a 5GSM timer is running or activated, and the external server may transmit information on whether the 5GSM timer is running or activated to the UE. Accordingly, the UE may determine (or, identify or check) whether the 5GSM times is running or activated.

In step S30, the UE may be prohibited from transmitting data over the control plane when the 5GSM timer is running or activated. For example, the UE may not transmit data over the control plane in step S30.

when there is no such timer running, the UE may be allowed to transmit data over the control plane in step S20. For example, the UE may transmit data over the control plane in step S20.

FIG. 2 is a flowchart illustrating an embodiment of the present disclosure.

In step S110, a check is made to determine if a connected network has sent (or sends) a BO timer to the UE without an associated 5GMM cause. For example, the UE determine (or, identify) whether a connected network sends a BO timer to the UE without an associated 5GMM cause. As another example, an external server may identify whether a connected network sends a BO timer to the UE without an associated 5GMM cause, and the external server may transmit information on whether the connected network sends the BO timer to the UE without an associated 5GMM cause to the UE. Accordingly, the UE may determine (or, identify or check) whether the connected network sends the BO timer to the UE without an associated 5GMM cause.

In step S130, the UE may be prohibited from sending (or transmitting, delivering, transferring, transporting) data over the control plane (CP). For example, the UE may not transmit data over the control plane in step S130.

In step S120, the UE may be allowed to transmit data over the control plane (CP). For example, the UE may transmit data over the control plane in step S120.

FIG. 3 illustrates a structure of a UE according to an embodiment of the disclosure.

As shown in FIG. 3, the UE according to an embodiment may include a transceiver 310, a memory 320, and a processor 330. The transceiver 310, the memory 320, and the processor 330 of the UE may operate according to a communication method of the UE described above. However, the components of the UE are not limited thereto. For example, the UE may include more or fewer components than those described above. In addition, the processor 330, the transceiver 310, and the memory 320 may be implemented as a single chip. Also, the processor 330 may include at least one processor. Furthermore, the UE of FIG. 3 corresponds to the UE of the FIG. 1 to FIG. 2.

The transceiver 310 collectively refers to a UE receiver and a UE transmitter, and may transmit/receive a signal to/from a base station or a network entity. The signal transmitted or received to or from the base station or a network entity may include control information and data. The transceiver 310 may include a RF transmitter for upconverting and amplifying a frequency of a transmitted signal, and a RF receiver for amplifying low-noise and down-converting a frequency of a received signal. However, this is only an example of the transceiver 310 and components of the transceiver 310 are not limited to the RF transmitter and the RF receiver.

Also, the transceiver 310 may receive and output, to the processor 330, a signal through a wireless channel, and transmit a signal output from the processor 330 through the wireless channel.

The memory 320 may store a program and data required for operations of the UE. Also, the memory 320 may store control information or data included in a signal obtained by the UE. The memory 320 may be a storage medium, such as read-only memory (ROM), random access memory (RAM), a hard disk, a CD-ROM, and a DVD, or a combination of storage media.

The processor 330 may control a series of processes such that the UE operates as described above. For example, the transceiver 310 may receive a data signal including a control signal transmitted by the base station or the network entity, and the processor 330 may determine a result of receiving the control signal and the data signal transmitted by the base station or the network entity.

FIG. 4 illustrates a structure of a base station according to an embodiment of the disclosure.

As shown in FIG. 4, the base station according to an embodiment may include a transceiver 410, a memory 420, and a processor 430. The transceiver 410, the memory 420, and the processor 430 of the base station may operate according to a communication method of the base station described above. However, the components of the base station are not limited thereto. For example, the base station may include more or fewer components than those described above. In addition, the processor 430, the transceiver 410, and the memory 420 may be implemented as a single chip. Also, the processor 430 may include at least one processor. Furthermore, the base station of FIG. 4 corresponds to the BS of the FIG. 1 to FIG. 2.

The transceiver 410 collectively refers to a base station receiver and a base station transmitter, and may transmit/receive a signal to/from a terminal (UE) or a network entity. The signal transmitted or received to or from the terminal or a network entity may include control information and data. The transceiver 410 may include a RF transmitter for up-converting and amplifying a frequency of a transmitted signal, and a RF receiver for amplifying low-noise and down-converting a frequency of a received signal. However, this is only an example of the transceiver 410 and components of the transceiver 410 are not limited to the RF transmitter and the RF receiver.

Also, the transceiver 410 may receive and output, to the processor 430, a signal through a wireless channel, and transmit a signal output from the processor 430 through the wireless channel.

The memory 420 may store a program and data required for operations of the base station. Also, the memory 420 may store control information or data included in a signal obtained by the base station. The memory 420 may be a storage medium, such as read-only memory (ROM), random access memory (RAM), a hard disk, a CD-ROM, and a DVD, or a combination of storage media.

The processor 430 may control a series of processes such that the base station operates as described above. For example, the transceiver 410 may receive a data signal including a control signal transmitted by the terminal, and the processor 430 may determine a result of receiving the control signal and the data signal transmitted by the terminal.

An aspect of the disclosure provides a method of controlling an user equipment (UE) transmitting data over a control plane (CP) including prohibiting the UE from transmitting the data over the CP when a 5G Session Management (5GSM) timer is running.

The UE may be prohibited from transmitting the data over at least one of a non-access stratum (NAS) associated with a Data Network Name (DNN), a slice identification (ID), single network slice selection assistance information (S-NSSAI), or a combination of the S-NSSAI and DNN.

The method may include prohibiting the UE from initiating a service request procedure or a non-access stratum (NAS) transport procedure for the transmitting the data over the CP when a timer T3396 may be running or deactivated.

The method may include prohibiting the UE from initiating a service request procedure or a non-access stratum (NAS) transport procedure for the transmitting the data over the CP when a timer T3584 is running or deactivated.

The method may include prohibiting the UE from initiating a service request procedure or a non-access stratum (NAS) transport procedure for transmitting the data over the CP when timer a T3585 is running or deactivated.

Prohibition may be lifted when the UE is configured for high priority access or to report a change of 3GPP PS data off UE status.

The method may include sending to the UE a Back Off (BO) timer without an associated 5GMM cause, and blocking data transmission over the CP.

The UE may stop the BO timer when cellular internet of things (CIoT) user data is received. The BO timer may be one of T3396, T3584 and T3585.

The UE may be configured to operate in a S1 mode and the UE may be configured to receive an evolved packet system session management (ESM DATA) transport message directly as a non-access stratum (NAS) message.

An aspect of the disclosure provides an user equipment (UE) transmitting data over a control plane (CP) and including a transceiver, and at least one processor coupled with the transceiver and configured to be prohibited to transmit the data over the CP when a 5G Session Management (5GSM) timer is running.

The UE may be configured to be prohibited from transmitting the data over at least one of a non-access stratum (NAS) associated with a Data Network Name (DNN), a slice identification (ID), single network slice selection assistance information (S-NSSAI), or a combination of the S-NSSAI and DNN.

The UE may be configured to be prohibited from initiating a service request procedure or a non-access stratum (NAS) transport procedure for the transmitting the data over the CP when a timer T3396 is running or deactivated.

The UE may be configured to be prohibited from initiating a service request procedure or a non-access stratum (NAS) transport procedure for the transmitting the data over the CP when a timer T3584 is running or deactivated.

The UE may be configured to be prohibited from initiating a service request procedure or a non-access stratum (NAS) transport procedure for transmitting the data over the CP when timer a T3585 is running or deactivated.

Prohibition may be lifted when the UE is configured for high priority access or to report a change of 3GPP PS data off UE status.

The UE may be configured to receive a Back Off (BO) timer without an associated 5GMM cause, and the UE does not transmit the data over the CP in response to receiving the BO timer.

The UE may stop the BO timer when cellular internet of things (CIoT) user data is received.

The BO timer may be one of T3396, T3584 and T3585.

The UE may be configured to operate in a S1 mode and the UE may be configured to receive an evolved packet system session management (ESM DATA) transport message directly as a non-access stratum (NAS) message.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

1-15. (canceled)

16. A method performed by a user equipment (UE) in a wireless communication system, the method comprising:
identifying cellular internet of things (CIoT) user data to be sent; and
in case that a back off (BO) timer is running or deactivated, and the UE is configured for a high priority access in a public land mobile network (PLMN), initiating a non access stratum (NAS) transport procedure for sending the CIoT user data,
wherein the NAS transport procedure is not allowed to be initiated, in case that the BO timer is running or deactivated, and the UE is not configured for the high priority access in the PLMN.

17. The method of claim 16, wherein the NAS transport procedure is initiated, in case that the BO timer is running or deactivated, and the UE is configured to report a change of packet switch (PS) data off UE status, and
wherein the NAS transport procedure is not allowed to be initiated, in case that the BO timer is running or deactivated, and the UE is not configured to report the change of the PS data off UE status.

18. The method of claim 16, wherein the BO timer includes at least one of a first BO timer associated with a data network name (DNN), a second BO timer associated with a combination of the DNN and a single network slice selection assistance information (S-NSSAI), or a third BO timer associated with the S-NSSAI.

19. The method of claim 18, wherein the first BO timer includes a T3396 timer, the second BO timer includes a T3584 timer, and the third BO timer includes a T3585 timer.

20. The method of claim 16, wherein the CIoT user data is transmitted to a base station via a control plane based on the NAS transport procedure.

21. The method of claim 16, further comprising:
receiving, from a base station, a message including a value of the BO timer; and
starting the BO timer based on the value of the BO timer.

22. The method of claim 16, wherein the BO timer corresponds to a fifth generation session management (5GSM) timer.

23. The method of claim 16, further comprising:
stopping the BO timer in case that CIoT user data is received from a base station.

24. A user equipment (UE) in a wireless communication system, the UE comprising:
a transceiver; and
a controller coupled with the transceiver and configured to:
identify cellular internet of things (CIoT) user data to be sent, and
in case that a back off (BO) timer is running or deactivated, and the UE is configured for a high priority access in a public land mobile network (PLMN), initiate a non access stratum (NAS) transport procedure for sending the CIoT user data,
wherein the NAS transport procedure is not allowed to be initiated, in case that the BO timer is running or deactivated, and the UE is not configured for the high priority access in the PLMN.

25. The UE of claim 24, wherein the NAS transport procedure is initiated, in case that the BO timer is running or deactivated, and the UE is configured to report a change of packet switch (PS) data off UE status, and
wherein the NAS transport procedure is not allowed to be initiated, in case that the BO timer is running or deactivated, and the UE is not configured to report the change of the PS data off UE status.

26. The UE of claim 24, wherein the BO timer includes at least one of a first BO timer associated with a data network name (DNN), a second BO timer associated with a combination of the DNN and a single network slice selection assistance information (S-NSSAI), or a third BO timer associated with the S-NSSAI.

27. The UE of claim 26, wherein the first BO timer includes a T3396 timer, the second BO timer includes a T3584 timer, and the third BO timer includes a T3585 timer.

28. The UE of claim 24, wherein the CIoT user data is transmitted to a base station via a control plane based on the NAS transport procedure.

29. The UE of claim 24, wherein the controller is further configured to:
receive, from a base station, a message including a value of the BO timer, and
start the BO timer based on the value of the BO timer.

30. The UE of claim 24, wherein the BO timer corresponds to a fifth generation session management (5GSM) timer.
